(19) United States
(12) Patent Application Publication
(10) Pub. No.: US 2026/0029965 A1
(43) Pub. Date: Jan. 29, 2026

(54) STORAGE SYSTEM

(71) Applicant: Hitachi Vantara, Ltd., Yokohama-shi (JP)

(72) Inventors: Sachie TAJIMA, Tokyo (JP); Shintaro ITO, Tokyo (JP); Takahiro YAMAMOTO, Tokyo (JP)

(21) Appl. No.: 19/068,377

(22) Filed: Mar. 3, 2025

(30) Foreign Application Priority Data
Jul. 26, 2024 (JP) 2024-121435

(51) Int. Cl. G06F 3/06

(52) U.S. Cl. CPC G06F 3/067; G06F 3/0604; G06F 3/0632; G06F 3/0659

(57) ABSTRACT

The write performance of a storage system is improved. A storage system includes a processor and a memory. The memory stores a first control program, a second control program in a control layer different from that of the first control program, first format management information that manages a format state of each storage area of a storage device, and second format management information that manages the format state of each storage area of the storage device. In registering a volume, the processor sets a region in the storage device, the region being assigned to the volume, to a formatted state in the first format management information according to the first control program, and sets an actual format state of the region in the storage device, the region being assigned to the volume, in the second format management information according to the second control program.

### CLAIM OF PRIORITY

The present application claims priority from Japanese patent application JP 2024-121435 filed on Jul. 26, 2024, the content of which is hereby incorporated by reference into this application.

### BACKGROUND OF THE INVENTION

### 1. Field of the Invention

The present invention relates to a format bit management of a storage program.

### 2. Description of the Related Art

In a software defined storage (SDS) as a storage device, the format state of a data region may be managed to ensure that zero data is stored in an unformatted region. For a request to read the unformatted region, the SDS returns zero data without drive access.

An example of the related art is disclosed in PCT Patent Publication No. WO2018/051392.

### SUMMARY OF THE INVENTION

The storage device that provides various functions may include some programs for each function. In this case, the format state may be managed in different data sizes for the respective programs, and a program in an upper layer may use a management size larger than that of a program in a lower layer.

When writing to the unformatted region occurs, even in a case of a write request for a small size, the program in the upper layer performs zero filling of data until a management size is attained, and passes the write request to the lower layer. For the program in the lower layer, a data write exceeding a management data size is requested. A performance degradation occurs because a write size that has been a small size is increased. It is an object to resolve the degradation.

A similar performance degradation occurs also in a case where the program in the lower layer uses a management size larger than that of the program in the upper layer.

According to one aspect of the present invention, there is provided a storage system including a processor and a memory, the memory being configured to store a first control program, a second control program in a control layer different from that of the first control program, first format management information configured to be referred to by the first control program and manage a format state of each storage area of a storage device by a first management unit, and second format management information configured to be referred to by the second control program and manage the format state of each storage area of the storage device by a second management unit, and the processor being configured to, in registering a volume, set a region in the storage device, the region being assigned to the volume, to a formatted state in the first format management information according to the first control program, and set an actual format state of the region in the storage device, the region being assigned to the volume, in the second format management information according to the second control program.

According to one embodiment of the present invention, the write performance of the storage system is improved.

### BRIEF DESCRIPTION OF THE DRAWINGS

FIG. 1 is an apparatus configuration diagram illustrating an environment according to a first embodiment;

FIG. 2 is a physical configuration diagram of storage nodes;

FIG. 3 is a logical configuration diagram of storage nodes;

FIG. 4 is a configuration diagram of a memory of a storage node;

FIG. 5 is a flowchart of volume registration processing in the first embodiment;

FIG. 6 is a flowchart of volume deletion processing in the first embodiment;

FIG. 7 is a configuration diagram of a memory of a storage node in a third embodiment;

FIG. 8 is a flowchart of volume deletion processing in the third embodiment; and

FIG. 9 is a flowchart of correction read processing in the third embodiment.

### DESCRIPTION OF THE PREFERRED EMBODIMENTS

In the following, embodiments of the present invention will be described with reference to the drawings. However, the present invention is not to be construed to be limited to the described contents of the embodiments to be illustrated in the following. It would easily be understood by those skilled in the art that specific configurations of the present invention can be changed without departing from the concept or spirit of the present invention.

Such expressions as “first,” “second,” and “third” in the present specification and the like are provided to identify constituent elements, and do not necessarily limit numbers or orders of the constituent elements. In configurations of the invention to be described in the following, identical or similar configurations or functions are identified by the same reference numerals, and repeated description thereof will be omitted.

In addition, in the following description, common reference numerals (or reference numerals) in reference numerals may be used when elements of the same kind are described without being distinguished from each other, and reference numerals (or identifiers (IDs) of elements) may be used when elements of the same kind are described to be distinguished from each other.

A program is executed by a processor (for example, a central processing unit (CPU)) included in a storage controller in a storage device. Specified processing is thereby performed while storage resources (for example, a memory) and/or a communication interface device (for example, a host interface (I/F)) is (are) used as appropriate. A subject of the processing may therefore be the storage device or the processor. In addition, the storage controller may include a hardware circuit that performs a part or the whole of the processing. A computer program may be installed from a program source. The program source may be, for example, a program distributing server or a computer readable storage medium.

### First Embodiment

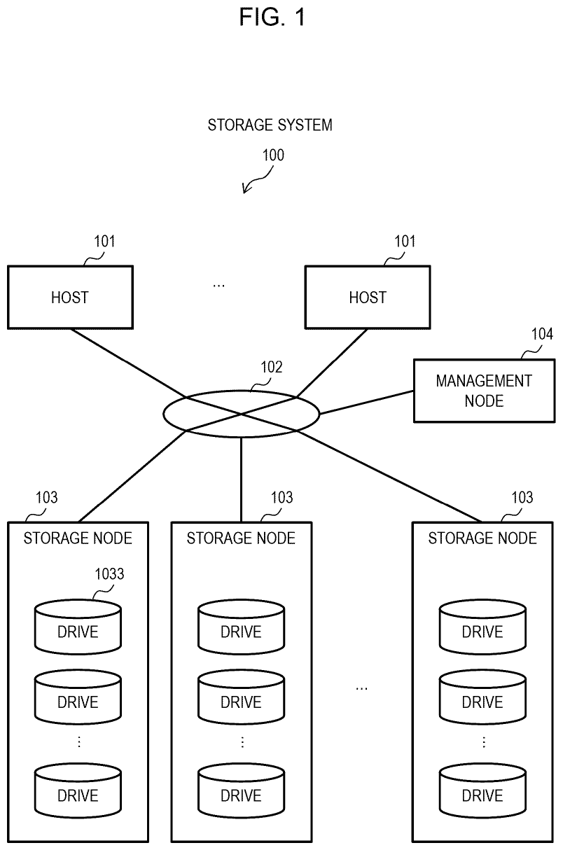

FIG. 1 illustrates a configuration of a system according to a first embodiment.

A storage system 100 includes, for example, a plurality of host devices 101 (Hosts), a plurality of storage nodes 103 (Storage Nodes), and a management node 104 (Management Node). The host devices 101, the storage nodes 103, and the management node 104 are interconnected via a network 102 constituted by a fibre channel (FC), Ethernet, a local area network (LAN), or the like.

The host devices 101 are a general-purpose computer device that transmits a read request or a write request (these will hereinafter be referred to collectively as IO (Input Output) requests as appropriate) to a storage node 103 according to a user operation or a request from an implemented application program, for example. Incidentally, the host devices 101 may be a virtual computer device such as a virtual machine.

The storage nodes 103 are each a computer device that includes one or more storage devices (Drives) 1033 and provides a storage area for reading and writing data to the host devices 101. The storage nodes 103 are each a general-purpose server device, for example.

The management node 104 is a computer device that a system administrator uses to manage the whole of the present storage system 100. The management node 104 manages the plurality of storage nodes 103 as a group referred to as a cluster. Incidentally, while FIG. 1 illustrates an example in which only one cluster is provided, a plurality of clusters may be provided in the storage system 100.

As described above, the storage system 100 is constituted by two or more storage nodes 103, one or more host devices 101, and one management node 104. The configuration illustrated in the figure is illustrative. The host devices 101, the storage nodes 103, and the management node 104 may be an identical node. In addition, the host devices 101, the storage nodes 103, and the management node 104 may be implemented by a virtual machine or a container, or may be configured to coexist as processes.

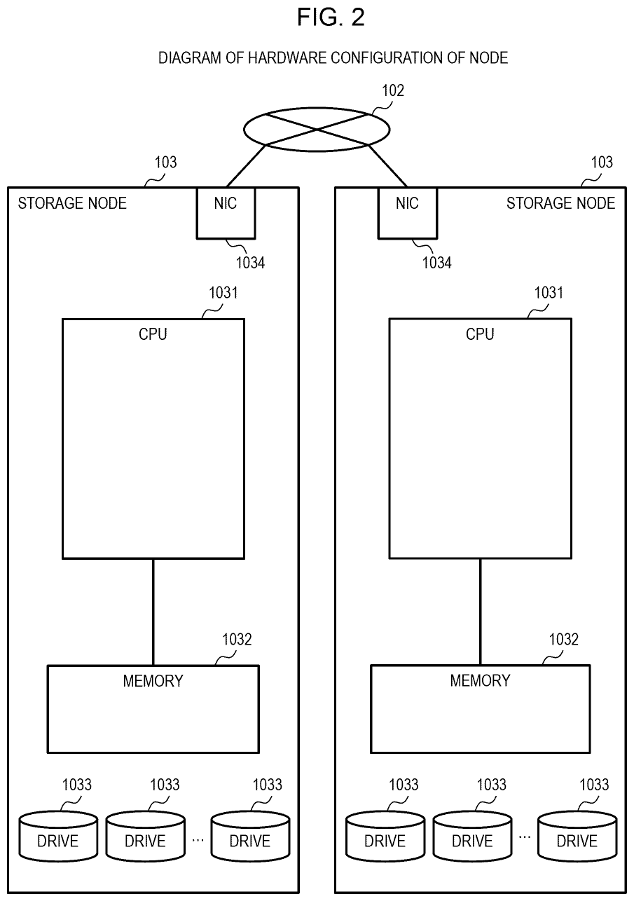

FIG. 2 is a diagram illustrating an example of physical configurations of storage nodes 103.

A storage node 103 includes a CPU 1031, a memory 1032, a plurality of storage devices 1033 (Drives), and a communicating device 1034 (Network Interface Card (NIC)).

The CPU 1031 is a processor in charge of controlling operation of the whole of the storage node 103. The memory 1032 is used to temporarily retain various kinds of programs and necessary data. The CPU 1031 performs the programs stored in the volatile memory 1032, and various kinds of processing of the storage node 103 as a whole as described later are thereby performed.

A storage device 1033 includes one or a plurality of kinds of high-capacity nonvolatile storage devices such as a solod state drive (SSD) and a hard disk drive. The storage device 1033 provides a physical storage area for reading or writing data according to an IO request from a host device 101.

The communicating device 1034 is an interface for the storage node 103 to perform communication with a host device 101, another storage node 103, or the management node 104 via the network 102. The communicating device 1034 is constituted by, for example, a NIC, an FC card, or the like. The communicating device 1034 performs protocol control at a time of communication with a host device 101, another storage node 103, or the management node 104.

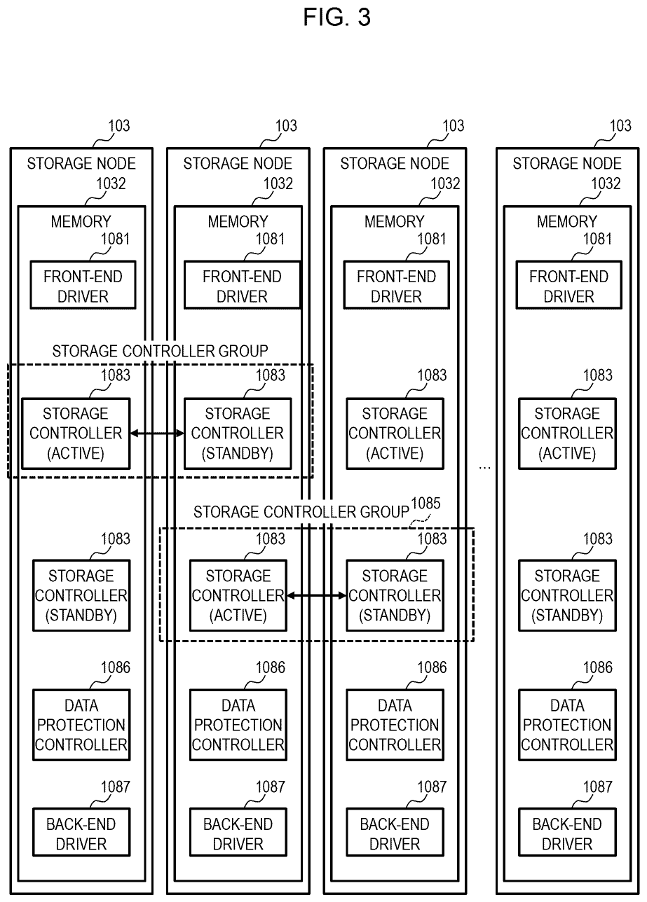

FIG. 3 is a diagram illustrating an example of logical configurations of storage nodes 103.

A storage node 103 includes a memory (Memory) 1032. The memory 1032 stores a plurality of programs. These programs are a front end driver 1081 (Front-end driver), a back end driver 1087 (Back-end driver), one or a plurality of storage controllers 1083 (Storage Controllers), and a data protection controller 1086 (Data Protection Controller). FIG. 3 illustrates two storage controllers 1083 in each node 103.

The front end driver 1081 is software that has functions of controlling the communicating device 1034 and providing a storage controller 1083 with an abstracted interface at a time of communication with a host device 101, another storage node 103, or the management node 104.

The back end driver 1087 is software that has functions of controlling each storage device 1033 in the own storage node 103 and providing an abstracted interface at a time of communication with each storage device 1033.

A storage controller 1083 is software that functions as a controller of software defined storage (SDS). The storage controller 1083 receives an IO request from the host device 101, and issues an IO command corresponding to the IO request to the data protection controller 1086.

In addition, the storage controller 1083 has a logical volume configuring function. The logical volume configuring function associates a logical chunk configured by the data protection controller 1086 and a logical volume provided to a host with each other. For example, a straight mapping system (that associates the logical chunk and the logical volume on a 1:1 basis and makes an address of the logical chunk and an address of the logical volume the same) may be adopted.

Alternatively, a virtual volume function (Thin Provisioning) system (a system that divides the logical volume and the logical chunk into regions (pages) of a small size and associates the addresses of the logical volume and the logical chunk with each other in page units) may be adopted.

Each storage controller 1083 implemented in the storage node 103 is managed as a pair that constitutes a redundant configuration together with another storage controller 1083 disposed in another storage node 103. In the following, this pair will be referred to as a storage controller group 1085.

Incidentally, FIG. 3 illustrates case where one storage controller group 1085 is constituted by two storage controllers 1083. One redundant configuration may be constituted by three or more storage controllers 1083. For example, one storage controller 1083 may be in an active mode, and another storage controller 1083 may be in a standby mode.

In the storage controller group 1085, one storage controller 1083 is set to be in a state of being able to receive an IO request from a host device 101 (this state is the state of an active system, and will hereinafter be referred to as an active mode). In addition, in the storage controller group 1085, the other storage controller 1083 is set to be in a state of not receiving the IO request from the host device 101 (this state is the state of a standby system, and will hereinafter be referred to as a standby mode). Incidentally, the node in the active mode will be referred to as an active node, and the node in the standby mode will be referred to as a standby node.

In the storage controller group 1085, in a case where a fault has occurred in the storage controller 1083 set to be in the active mode (hereinafter, referred to as an active storage controller) or the storage node 103 in which the active storage controller is disposed, for example, the state of the storage controller 1083 that has thus far been set to be in the standby mode (hereinafter, referred to as a standby storage controller) is changed to the active mode.

Thus, in a case where the active storage controller cannot operate, IO processing that has been performed by the active storage controller in question can be taken over by the standby storage controller. In order to implement this function, the standby storage node controller duplicates and retains a user data cache and control information included in the active storage node controller.

The data protection controller 1086 is software that has functions of assigning a physical storage area provided by a storage device 1033 in the own storage node 103 or in another storage node 103 to each storage controller group 1085 and reading or writing specified data from or to the corresponding storage device 1033 according to an IO command provided by a storage controller 1083.

When a physical storage area provided by a storage device 1033 in the other storage node 103 is assigned to the storage controller group 1085, the data protection controller 1086 reads or writes data from or to the storage area according to an IO command given from a storage controller 1083 of the storage controller group 1085, by cooperating with the data protection controller 1086 implemented in the other storage node 103 and exchanging, via the network 102, the data with the data protection controller 1086 implemented in the other storage node 103.

When the data protection controller 1086 is given an IO command, the data protection controller 1086 exchanges data with the data protection controller 1086 in the other storage node 103 via the network 102, and stores redundant data in the storage system 100. This prevents the occurrence of a data loss when a failure occurs in the storage node 103 or a storage device 1033 in the storage node 103. The data protection controller 1086 may implement the redundancy by mirroring, or may implement the redundancy by redundant array of independent disks (RAID) or Erasure Coding. The redundancy may be any of 1 and more.

As described above, a storage controller 1083 is a program in a higher layer, and the data protection controller 1086 is a program in a lower layer.

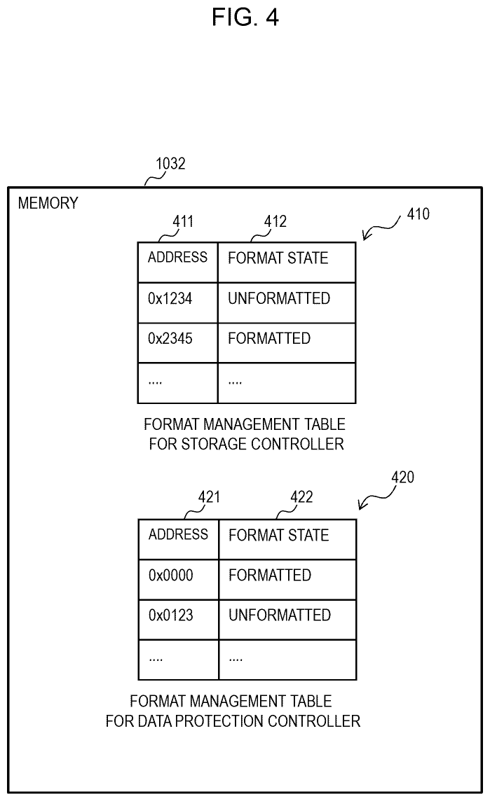

FIG. 4 illustrates tables stored by the memory 1032 of a storage node 103.

The memory 1032 has a format management table 410 for the storage controller and a format management table 420 for the data protection controller.

The format management table 410 for the storage controller manages whether a format state 412 of a region in a storage device 1033, the region being identified by an address 411 in a management unit of the storage controllers 1083, is unformatted or has been formatted.

The format management table 420 for the data protection controller manages whether a format state 422 of a region in a storage device 1033, the region being identified by an address 421 in a management unit of the data protection controller 1086, is unformatted or has been formatted.

A formatted state is a state in which data in the region is determinate for the storage controller 1083 or the data protection controller 1086. The determinate data in the formatted region is user data or zero data, for example. An unformatted state is a state in which data in the region is indeterminate. Incidentally, any specified data different from the zero data can be used.

The format management table 410 for the storage controller and the format management table 420 for the data protection controller manage the same physical storage area in the storage device 1033. However, addresses and format states thereof are independently managed by the respective programs. That is, the two management tables 410 and 420 manage a common physical region in different address spaces. The management units of the respective programs may have the same size, or may have different sizes.

For example, the management unit of the format management table 410 for the storage controller is larger than the management unit of the format management table 420 for the data protection controller. In this configuration, the present embodiment can improve write performance more effectively. In an example, the size of the management unit of the format management table 410 for the storage controller is 2 MB, and the size of the management unit of the format management table 420 for the data protection controller is 256 KB. These sizes are larger than the size of an access unit (for example, 4 KB) of a host.

A storage controller 1083 refers to the format management table 410 for the storage controller when reading data in a storage device 1033.

When the region has been formatted, the data protection controller 1086 is instructed to read the data in the region. However, when the region is unformatted, zero data is returned without an instruction being given to the data protection controller 1086.

When the storage controller 1083 writes data in a storage device 1033, the storage controller 1083 refers to the format management table 410 for the storage controller, and changes the state of the region to a formatted state in a case where the region is unformatted. In addition, in a case where the region is unformatted and the size of the data to be written is less than the management size of the storage controller 1083, the size of the data to be written is filled with zero data until the management size is attained, and then, the data protection controller 1086 is instructed to write the data.

The data protection controller 1086 similarly refers to the format management table 420 for the data protection controller and performs reading and writing in response to an instruction from the storage controller 1083. That is, in a case where the region has been formatted, the storage device 1033 is instructed to read the data in the region, whereas, in a case where the region is unformatted, zero data is returned to the storage controller 1083 without an instruction being given to the storage device 1033.

When the data protection controller 1086 writes data in the storage device 1033, the data protection controller 1086 refers to the format management table 420 for the data protection controller, and changes the state of the region to a formatted state in a case where the region is unformatted. In addition, in a case where the region is unformatted and the size of the data to be written is less than the management size of the data protection controller 1086, the size of the data to be written is filled with zero data until the management size is attained, and then, the storage device 1033 is instructed to write the data.

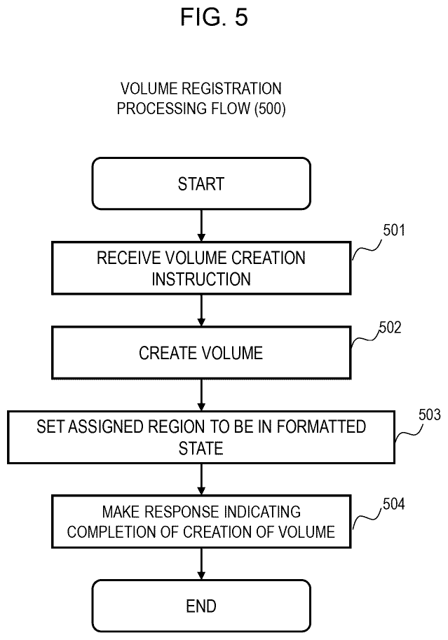

FIG. 5 illustrates an example of a volume registration processing flow 500.

The storage controller 1083 receives a volume creation instruction from a user (step 501). The storage controller 1083 generates management information regarding a relevant volume, then instructs the data protection controller 1086 to assign the volume a region from a storage device 1033, and creates the volume (step 502). The storage controller 1083 sets the format state of the assigned region in the format management table 410 for the storage controller to a formatted state (step 503).

The storage controller 1083 makes a response indicating completion of the creation of the volume to the user (step 504).

The storage controller 1083 may instruct the data protection controller 1086 to write zero data to the storage device 1033 for the region assigned to the volume, in asynchronism with the volume registration processing after making the response indicating the completion of the creation of the volume. The performance of initial writing can thereby be improved. The data protection controller 1086 may actually write zero, or may use WRITE SAME or a TRIM (small computer system interface (SCSI) command). The data protection controller 1086 may write zero data to the region without receiving an instruction from the storage controller 1083. The data protection controller 1086 may not write zero data.

When the storage controller 1083 receives a first data write request for the region of the volume after the creation of the volume, the storage controller 1083 refers to the format state 412 of the region in the format management table 410 for the storage controller. In a case where the format state 412 is unformatted, a remaining region of the management unit is filled with zero, and then, the data protection controller 1086 is requested to write data in the management unit of the storage controller 1083.

In a case where the format state 412 of the region in the format management table 410 for the storage controller has been formatted, the data protection controller 1086 is requested to write the requested data.

In the volume registration processing flow 500 illustrated in FIG. 5, the storage controller 1083 sets the format of the volume assigned region to be in a formatted state. Therefore, first data writing is requested of the data protection controller 1086 with a requested size unchanged without zero filling for extension to the management unit of the storage controller 1083. The format management of the region is performed by the data protection controller 1086. It is thereby possible to improve write performance.

The data protection controller 1086 checks the format state 422 of the region in the format management table 420 for the data protection controller. In a case of a write request for the region in an unformatted state, the data protection controller 1086 fills a remaining region of the management unit with zero, and then writes the received data to the storage device 1033.

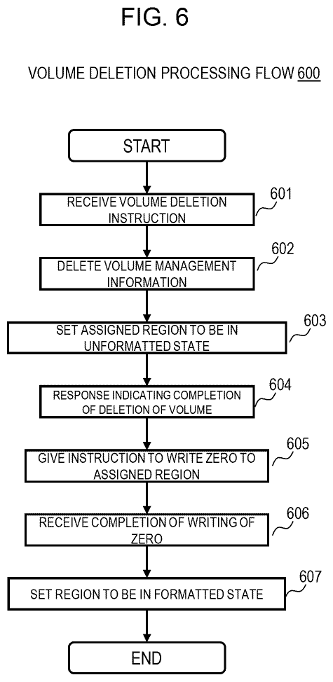

FIG. 6 illustrates a volume deletion processing flow 600.

The storage controller 1083 receives a volume deletion instruction from the user (step 601). The storage controller 1083 deletes the management information regarding the volume (step 602), and sets the format state 412 of the region assigned to the volume in the format management table 410 for the storage controller to an unformatted state (step 603). In the format management table 420 for the data protection controller, the format state of the region remains a formatted state. Setting only one of the format state 412 of the region in the format management table 410 for the storage controller and the format state of the region in the format management table 420 for the data protection controller to the unformatted state makes it possible to simplify subsequent format processing.

The storage controller 1083 makes a response indicating completion of the deletion of the volume to the user (step 604).

After the storage controller 1083 makes the response indicating the completion of the deletion of the volume, the storage controller 1083 instructs the data protection controller 1086 to write zero to the region assigned to the volume, in asynchronism with the deletion of the volume (step 605). It is thereby possible to reduce an effect of zero writing on IO performance. The data protection controller 1086 writes zero to the specified region. At this time, the data protection controller 1086 may actually write zero, or may use WRITE SAME or TRIM. When the storage controller 1083 receives a response indicating completion of the zero writing from the data protection controller 1086 (step 606), the storage controller 1083 sets the format state 412 of the region assigned to the volume in the format management table 410 for the storage controller to a formatted state (step 607).

Incidentally, steps following step 605 may not be performed.

In the above-described configuration example, the storage controller 1083 in an upper layer sets the format information regarding all of regions to be in a formatted state at a time of construction of a volume, and the data protection controller 1086 in a lower layer manages an actual format state in the storage device 1033. In another configuration example, the management program in the lower layer sets the format information regarding all of the regions to be in a formatted state, and the management program in the upper layer may perform the actual format management. A load on the management program in the upper layer is typically large. It is therefore possible to achieve an improvement in system performance by simplifying the management in the upper layer.

The above-described configuration example of the storage system is a distributed storage system including a plurality of storage nodes 103. The format management in the embodiment can be applied to a storage system constituted by one node.

### Second Embodiment

A volume deletion processing flow according to a second embodiment will be illustrated. In the following, differences from the first embodiment will be described. The description of the first embodiment can be applied to configurations not particularly described.

The storage controller 1083 receives a volume deletion instruction from the user. The storage controller 1083 deletes the management information regarding the volume, and lets the format state of the region in the storage device 1033, the region being assigned to the volume, in the format management table 410 for the storage controller remain a formatted state without changing the format state. It is thereby possible to improve the write performance.

The storage controller 1083 requests the data protection controller 1086 to discard the region. The data protection controller 1086 changes the format state of the region in the format management table 420 for the data protection controller to an unformatted state.

### Third Embodiment

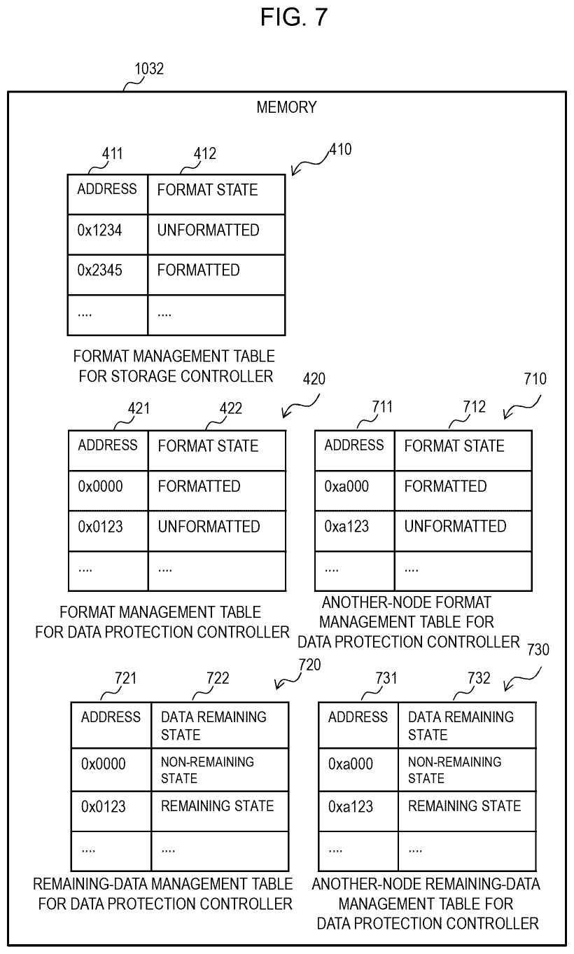

A third embodiment will be described in the following. In the third embodiment, description will be made of the decoding of data. FIG. 7 illustrates a table stored by the memory 1032 of a storage node 103 according to the third embodiment.

The memory 1032 stores, in addition to the tables described in the first embodiment, an another-node format management table 710 for the data protection controller, a remaining-data management table 720 for the data protection controller, and an another-node remaining-data management table 730 for the data protection controller.

The data protection controller 1086 performs data redundancy in the storage system 100 by using data stored in a storage device 1033 of another storage node 103 and cooperating with the data protection controller 1086 of the other storage node 103.

The another-node format management table 710 for the data protection controller manages whether a format state 712 of a region in a storage device 1033 in the other storage node 103, the region being identified by an address 711 in the management unit of the data protection controller 1086, is unformatted or has been formatted. The another-node format management table 710 for the data protection controller is prepared for each storage node 103 that cooperates for data decoding.

The remaining-data management table 720 for the data protection controller manages a data remaining state 722 of a region in a storage device 1033 in the storage node 103 in question, the region being identified by an address 721 in the management unit of the data protection controller 1086. In the data remaining state 722, an unformatted state in which data remains is managed as a remaining state, and the other state is managed as a non-remaining state.

The another-node remaining-data management table 730 for the data protection controller manages a data remaining state 732 of a region in a storage device 1033 in the other storage node 103, the region being identified by an address 731 in the management unit of the data protection controller 1086. The another-node remaining-data management table 730 for the data protection controller is prepared for each storage node 103 that cooperates for data decoding.

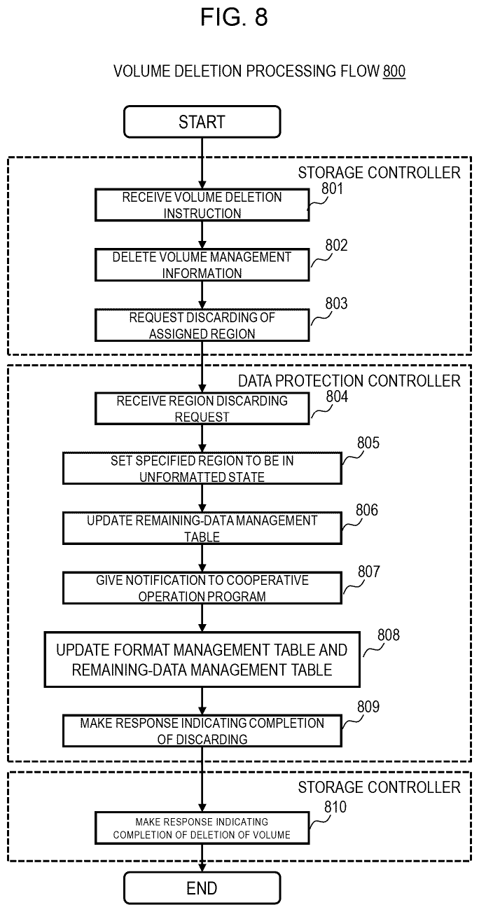

FIG. 8 illustrates a volume deletion processing flow 800 according to the third embodiment.

The storage controller 1083 receives a volume deletion instruction from the user (step 801). The storage controller 1083 deletes the management information regarding the volume (step 802), and requests the data protection controller 1086 to discard the corresponding region (step 803). At this time, the format management table 410 for the storage controller is not changed.

The data protection controller 1086 receives the request to discard the data region (step 804). For the specified region, the format state 412 in the format management table 420 for the data protection controller is set to an unformatted state (step 805), and the data remaining state 722 in the remaining-data management table 720 for the data protection controller is set to a remaining state (step 806).

The data protection controller 1086 gives, to the data protection controller 1086 of the other storage node 103 that cooperates, a notification of the changing of the format state of the data region to an unformatted state and the changing of the data remaining state to a remaining state (step 807).

Receiving a state change request, the data protection controller 1086 of the other storage node 103 updates the states in the another-node format management table 710 for the data protection controller and the another-node remaining-data management table 730 for the data protection controller (step 808).

The data protection controller 1086 of the other storage node 103 gives a notification of completion of the state update to the data protection controller 1086 that has received the request to discard the data region. The data protection controller 1086 makes a response indicating the completion of the discarding of the region to the storage controller 1083 (step 809). The storage controller 1083 makes a response indicating completion of the deletion of the volume to the user (step 810).

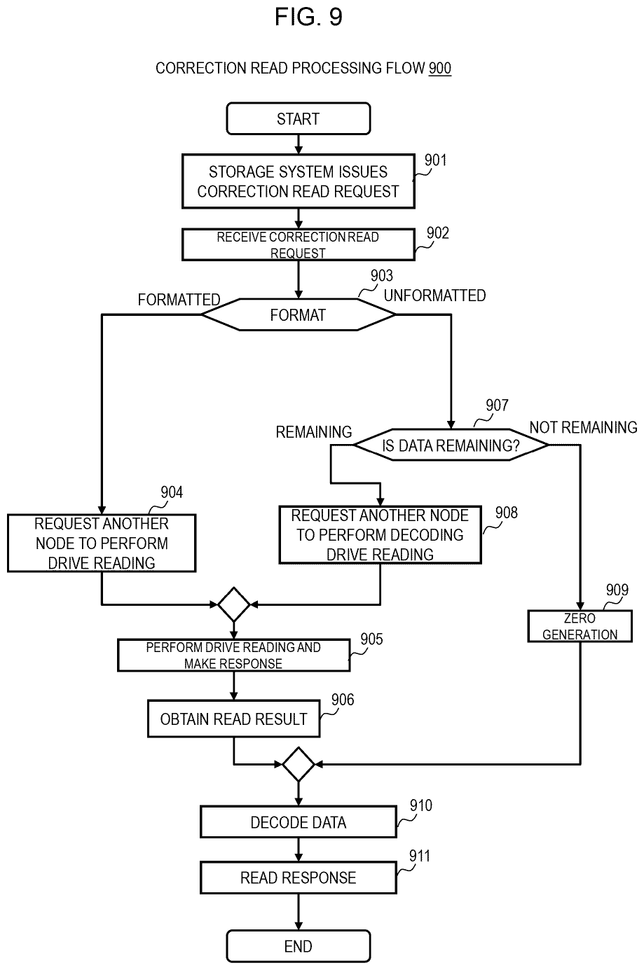

FIG. 9 illustrates a flow 900 of read processing (correction read processing) on a storage device 1033 in a fault occurrence storage node 103 according to the third embodiment.

A fault occurs in a storage node 103. When the user requests reading of a storage device 1033 in the fault occurrence storage node 103 from the storage system 100, the storage system 100 issues a correction read request to the data protection controller 1086 in a storage node 103 that can decode redundant data of data stored in the storage device 1033 (read-requested data) and in which no fault has occurred (step 901).

The data protection controller 1086 receives the correction read request (step 902). The data protection controller 1086 checks, in the another-node format management table 710 for the data protection controller, the format state of data stored in the storage device 1033 in the storage node 103 different from the node 103 that has received the correction read request, the data being necessary to decode the data in question (step 903). When the format state 712 of the region is a formatted state, the data protection controller 1086 in the other storage node 103 is requested to perform drive reading (step 904).

When the format state 712 of the region is an unformatted state in step 903, the data protection controller 1086 checks the data remaining state 732 of the region in the another-node remaining-data management table 730 for the data protection controller (step 907). When the data remaining state 732 is a remaining state, the data protection controller 1086 in the other storage node 103 is requested to perform decoding drive reading for reading the data from the drive even in the case where the format state is an unformatted state (step 908).

The other data protection controller 1086 that has received the read request makes a response indicating a read result to the data protection controller 1086 that has received the correction read request (step 905). The data protection controller 1086 receives the read result (step 906).

When the data remaining state 732 of the region is a non-remaining state in step 907, the data protection controller 1086 generates zero data as the read result (step 909).

The data protection controller 1086 decodes the data stored in the storage device 1033 in the storage node 103 in which the fault has occurred, by using the read result (step 910). The data protection controller 1086 makes a read response by using the decoded data (step 911).

In the present processing flow 900, description has been made of a case where a fault has occurred in a storage node 103. However, similar processing is performed also in a case where a fault has occurred in a storage device 1033 in the storage node 103.

Description will be made of processing according to the third embodiment, the processing recovering data stored in a faulty storage node 103 in a storage node 103 that is connected to the storage system 100 and in which no fault has occurred (rebuild processing).

The data stored in a storage device 1033 in the faulty storage node 103 is restored by the correction read processing 900.

The format management table 420 for the data protection controller, the another-node format management table 710 for the data protection controller, the remaining-data management table 720 for the data protection controller, and the another-node remaining-data management table 730 for the data protection controller in the other storage node 103 are referred to to restore the format management table 420 for the data protection controller, the another-node format management table 710 for the data protection controller, the remaining-data management table 720 for the data protection controller, and the another-node remaining-data management table 730 for the data protection controller.

Write processing according to the third embodiment on an unformatted region will be illustrated.

When the data protection controller 1086 receives a write request for the unformatted region, the data protection controller 1086 performs the zero filling of data according to the management unit. The data protection controller 1086 sets the format state 412 of the region in the format management table 420 for the data protection controller to a formatted state, and sets the remaining state 722 of the region in the remaining-data management table 720 for the data protection controller to a non-remaining state.

The data protection controller 1086 transmits data for the decoding of the write data to the data protection controller 1086 in another storage node 103 that operates in cooperation. At this time, the other data protection controller 1086 sets the format state 712 of the data storage region in the another-node format management table 710 for the data protection controller to a formatted state, and sets the remaining state 732 of the data storage region in the another-node remaining-data management table 730 for the data protection controller to a non-remaining state.

The present embodiment can restore data appropriately in a case where a fault has occurred in a storage node 103.

It is to be noted that the present invention is not limited to the foregoing embodiments and includes various modifications. For example, the foregoing embodiments are described in detail to describe the present invention in an easily understandable manner, and are not necessarily limited to embodiments including all of the described configurations. In addition, a part of a configuration of a certain embodiment can be replaced with a configuration of another embodiment, and a configuration of a certain embodiment can be added to a configuration of another embodiment. In addition, for a part of a configuration of each embodiment, another configuration can be added, deleted, or substituted.

In addition, a part or the whole of configurations, functions, processing units, and the like described above may be implemented by hardware by making design thereof by an integrated circuit (IC), for example. In addition, configurations, functions, and the like described above may be implemented by software by interpreting and executing a program implementing each function by a processor. Information such as a program, a table, and a file for implementing each function can be placed in a memory, a recording device such as a hard disk, an SSD, or the like, or a recording medium such as an IC card, a secure digital (SD) card, or the like.

In addition, control lines and information lines considered to be necessary for description are illustrated, and not all of control lines and information lines in a product are necessarily illustrated. Almost all of configurations may be considered to be interconnected in practice.

What is claimed is:

1. A storage system comprising:
a processor; and
a memory,
the memory being configured to store
a first control program,
a second control program in a control layer different from that of the first control program,
first format management information configured to be referred to by the first control program and manage a format state of each storage area of a storage device by a first management unit, and
second format management information configured to be referred to by the second control program and manage the format state of each storage area of the storage device by a second management unit, and
the processor being configured to, in registering a volume,
set a region in the storage device, the region being assigned to the volume, to a formatted state in the first format management information according to the first control program, and
set an actual format state of the region in the storage device, the region being assigned to the volume, in the second format management information according to the second control program.

2. The storage system according to claim 1, wherein,
in deleting the volume, the processor
sets the region of the volume in the storage device, the region being assigned to the volume, to an unformatted state in one of the first format management information and the second format management information, and
maintains the region of the volume in the storage device, the region being assigned to the volume, in a formatted state in the other of the first format management information and the second format management information.

3. The storage system according to claim 2, wherein,
in asynchronism with deleting the volume, the processor performs specified data writing processing for formatting the region in the storage device, the region being assigned to the volume, according to the second control program.

4. The storage system according to claim 1, wherein
the first control program is in a control layer higher than that of the second control program.

5. The storage system according to claim 4, wherein,
in deleting the volume, the processor
sets the region of the volume in the storage device, the region being assigned to the volume, to an unformatted state in the second format management information, and
maintains the region of the volume in the storage device, the region being assigned to the volume, in the formatted state in the first format management information.

6. The storage system according to claim 5, further comprising:
a plurality of nodes, wherein
each of the plurality of nodes includes the processor and the memory, and
the memory stores
another-node format management information configured to be referred to by the second control program and manage a format state of a decoding data region in another node,
own-node remaining-data management information configured to be referred to by the second control program and manage whether data remains in an own node, and
another-node remaining-data management information configured to be referred to by the second control program and manage whether decoding data remains in the another node.

7. The storage system according to claim 6, wherein,
in deleting the volume, the processor
sets the region in the storage device, the region being assigned to the volume, to an unformatted state in the second format management information, and
maintains data in the region in the storage device, the region being assigned to the volume, updates the own-node remaining-data management information, and gives, to the another node, a notification of update of the another-node format management information and the another-node remaining-data management information.

8. The storage system according to claim 6, wherein,
in correction reading, the processor reads data remaining in the region in the unformatted state in the storage device.

9. The storage system according to claim 6, wherein,
in a rebuild, the processor restores the second format management information, the another-node format management information, the own-node remaining-data management information, and the another-node remaining-data management information in a new node by using the data collected from the another node.

10. A format managing method in a storage system,
the storage system being configured to store
a first control program,
a second control program in a control layer different from that of the first control program,
first format management information configured to be referred to by the first control program and manage a format state of each storage area of a storage device by a first management unit, and
second format management information configured to be referred to by the second control program and manage the format state of each storage area of the storage device by a second management unit,
in registering a volume by the storage system, the method comprising:
setting a region in the storage device, the region being assigned to the volume, to a formatted state in the first format management information according to the first control program; and
setting an actual format state of the region in the storage device, the region being assigned to the volume, in the second format management information according to the second control program.
